(19) United States
(12) Patent Application Publication
(10) Pub. No.: US 2009/0121826 A1
(43) Pub. Date: May 14, 2009

(54) APPARATUS AND METHOD OF MANAGING QUALITY OF SLEEP

(76) Inventors: Sa Kwang SONG, Daejeon (KR); Jae Won JANG, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/136,837

(22) Filed: Jun. 11, 2008

(30) Foreign Application Priority Data
Nov. 8, 2007 (KR) 10-2007-0113626

(51) Int. Cl. G05B 23/02

(52) U.S. Cl. 340/3.1

(57) ABSTRACT

An apparatus of managing quality of sleep includes a weight sensor unit including a plurality of pressure sensors, which detect pressures in response to a presence and a movement of a user; an environment sensor including multiple sensors, which detect an environment surrounding the user in a sleep; and a controller for collecting and analyzing information, detected by the weight sensor unit and the environment sensor unit, and classifying and managing the analyzed information according to quality of sleep. The apparatus provides an optimized sleep environment adequate for a subject by learning various sleep environments, and provides a comfortable and cozy sleep environment to the subject to restore energy and be refreshed, so that the subject can enjoy energetic and effective daytime life.

### CROSS-REFERENCE TO RELATED APPLICATIONS

This application claims the priority of Korean Patent Application No. 10-2007-113626, filed on Nov. 8, 2007, in the Korean Intellectual Property Office, the disclosure of which is incorporated herein by reference.

### BACKGROUND OF THE INVENTION

1. Field of the Invention

The present invention relates to apparatus and method of managing the quality of sleep, in particular, which can detect and analyze sleep states of a subject using multiple sensors in order to provide the subject with an optimized sleep environment without contact or awakening.

This work was party supported by the IT R&D Program of MIC/IITA [2006-S007-02, Ubiquitous Health Monitoring Module and System Development].

2. Description of the Related Art

According to sleep medicine, human sleep is generally divided into a waking stage, sleep stages 1 to 4 and Rapid Eye Movement (REM) stage, and the quality of sleep is evaluated by analyzing respective sleep stages of a sleeper.

Well known technologies for the analysis of sleep stages of a sleeper include frequency analysis of electroencephalogram, Heart Rate Variability (HRV) analysis, oxygen saturation analysis, actigraph analysis using an accelerometer, and so on. Of these technologies, the oxygen saturation analysis and the actigraph analysis are used to analyze the sleep stages in a relatively inexpensive and simple fashion.

According to the technology of analyzing the sleep stages through the frequency analysis of electroencephalogram, a subject sleeps with electrodes placed on the scalp. However, the electrodes cause inconvenience to the subject. Since an electroencephalogram amplifier is very expensive, this technology can be used for only an expert test in a hospital.

In the case of the HRV analysis, a sleeper feels uneasy if electrodes are used. Conventionally, there is also a technology of detecting HRV by non-contact electrocardiography using conductive fibers. This technology, however, also has a drawback in that the conductive fibers closely contact the skin of the sleeper.

Furthermore, in the oxygen saturation analysis, sensors are worn on fingers and/or ears, thereby causing inconvenience to the sleeper. In the case of the actigraph analysis, an accelerometer is worn on the wrist or the waist of a patient, and thus the patient still feels uneasy.

When a patient does not progresses from a light sleep stage (stage 1 or 2) to a deep sleep stage (stage 3 or 4) due to snoring or insomnia, he/she suffers from excessive daytime sleepiness, which causes poor quality of life. In order to analyze the sleep stages, electroencephalography is carried out based upon polysomnography in a hospital. In the electroencephalography, the electroencephalogram of a sleeper is divided according to frequency ranges, and respective sleep stages are grasped based upon the intensities of the frequency ranges.

The electroencephalography, however, is carried out with electrodes placed on the scalp of patients. Therefore, the patients rarely take sleep patterns as usual owing to the electrodes, to which they are unaccustomed.

According to a technology of measuring typical phenomena of sleep, there are developed a motion sensor having an accelerometer, which is worn on the wrist or the waist to measure movements and states, and a device of measuring a weight change in a bed using load cells, thereby assessing sleep patterns.

However, the problem of the motion sensor worn on the wrist or the waist is that a patient feels uneasy when he/she sleeps. The device of assessing sleep patterns also has a limited ability to detect or analyze sleep environments. Furthermore, these devices fail to provide a sleep environment adequate for the user.

### SUMMARY OF THE INVENTION

The present invention has been made to solve the foregoing problems with the prior art, and therefore the present invention provides apparatus and method of managing the quality of sleep, which analyze and detect the sleep environment of a user by using multiple sensors and an actuator, learn sleep habits of the user for one day or more, and provide the user with an optimized environment without contact or awakening.

The invention also provides apparatus and method of managing the quality of sleep, by which electronic appliances can be controlled to construct and learn user profiles in an environment without contact or awakening.

According to an aspect of the invention, the apparatus of managing quality of sleep includes a weight sensor unit including a plurality of pressure sensors, which detect pressures in response to a presence and a movement of a user; an environment sensor unit including multiple sensors, which detect an environment surrounding the user in a sleep; and a controller for collecting and analyzing information, detected by the weight sensor unit and the environment sensor unit, and classifying and managing the analyzed information according to quality of sleep.

According to another aspect of the invention, the method of managing quality of sleep includes procedures of: detecting, pressure of a presence and a movement of a user by a plurality of pressure sensors, and an environment surrounding a user in a sleep by multiple sensors; collecting pressures, detected by the pressure sensors, and multiple sensor information, detected by the multiple sensors; analyzing collected information, which includes the pressures and the multiple sensor information; and classifying the analyzed information according to quality of sleep and managing the classified information of quality of sleep.

As set forth above, the present invention can analyze and manage sleep-related information detected by weight sensors and multiple sensors in an environment without contact or awakening. As a result, the invention can provide an optimized sleep environment adequate for a subject by learning various sleep environments, and provide a comfortable and cozy sleep environment to the subject to restore energy and be refreshed, so that the subject can enjoy energetic and effective daytime life.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a concept of managing the quality of sleep according to an embodiment of the invention;

FIG. 2 is a schematic view illustrating an apparatus of managing the quality of sleep according to an embodiment of the invention;

FIG. 3 is a schematic view illustrating the structure of a weight sensor unit of the apparatus of managing the quality of sleep according to the invention;

FIG. 4 is a schematic view illustrating the structure of an environment sensor unit of the apparatus of managing the quality of sleep according to the invention;

FIG. 5 is a schematic view illustrating mounting areas of PIR sensors of the environment sensor unit and sensing areas thereof;

FIG. 6 is a block diagram illustrating the structure of a controller of the apparatus of managing the quality of sleep according to the invention;

FIG. 7 is a process diagram illustrating a process of collecting information, detected by a plurality of sensors, and additional information, according to an embodiment of the invention;

FIG. 8 is a flowchart illustrating a process of collecting sleep-related information and analyzing sleep states according to an embodiment of the invention; and

FIG. 9 is a flowchart illustrating a process of analyzing the quality of sleep in the apparatus of managing the quality of sleep according to an embodiment of the invention.

### DETAILED DESCRIPTION OF THE EXEMPLARY EMBODIMENTS

The present invention will now be described more fully with reference to the accompanying drawings, in which exemplary embodiments thereof are shown. Descriptions of well-known functions and constructions are omitted for clarity and conciseness.

In the exemplary embodiment of the invention, it will be described of apparatus and method of managing the quality of sleep without contact or awakening, which are devised to provide an optimized environment to a user. First, the construction of the apparatus of managing the quality of sleep will be described in detail with reference to the accompanying drawings.

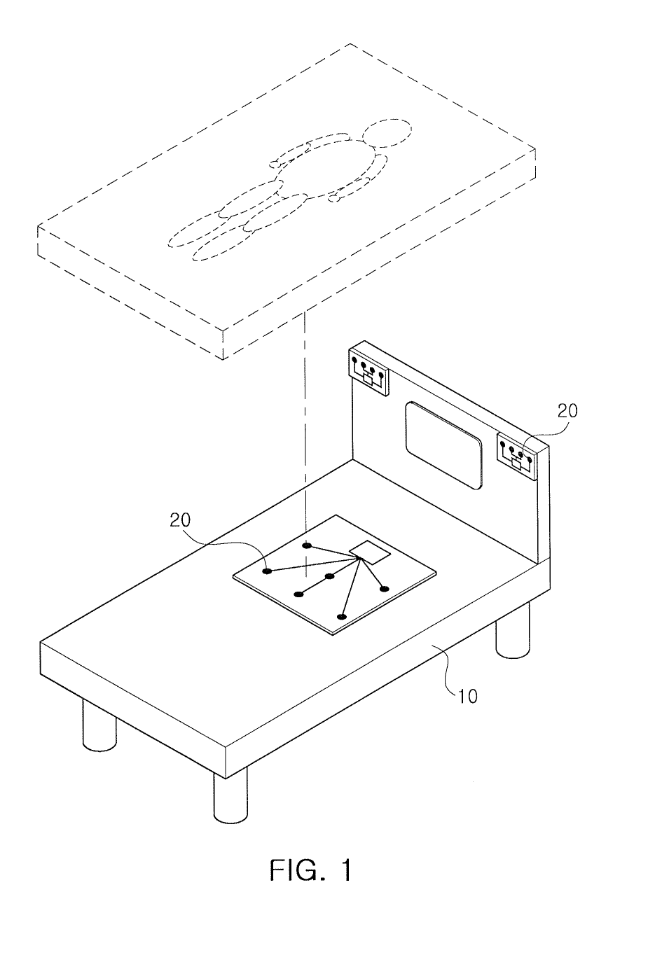

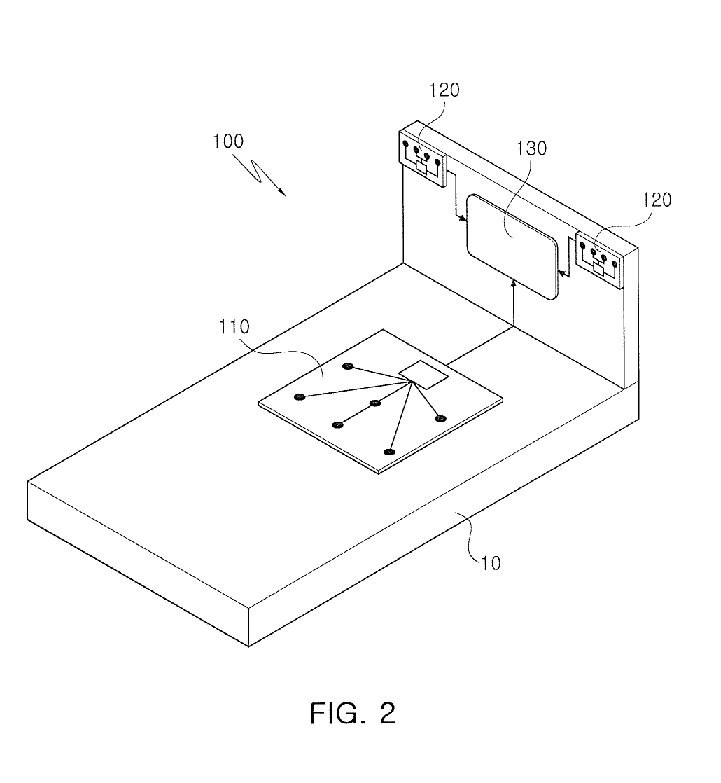

FIG. 1 is a schematic view illustrating a concept of managing the quality of sleep according to an embodiment of the invention, and FIG. 2 is a schematic view illustrating an apparatus of managing the quality of sleep according to an embodiment of the invention.

As shown in FIG. 1, the apparatus of managing the quality of sleep includes plural types of sensors 20 (hereinafter referred to as “multiple sensors”) mounted on a bed 10 and a mattress (not shown) of the bed 10, on which a user lies. Alternatively, the apparatus of managing the quality of sleep may be mounted on different places and/or objects where the user sleeps.

Referring to FIG. 2, the apparatus of managing the quality of sleep 100 includes a weight sensor unit 110, environment sensor units 120 and a controller 130. The apparatus may also include a database (not shown) that stores information necessary for the management of the quality of sleep. The database may be installed in the bed or be provided separately. For example, in the case where the database is separately provided in a remote position, the controller 130 can store corresponding information in the database via wireless communication. Furthermore, the apparatus of managing the quality of sleep 100 can be connected to an internet via communication with an external or home computer or a communication device.

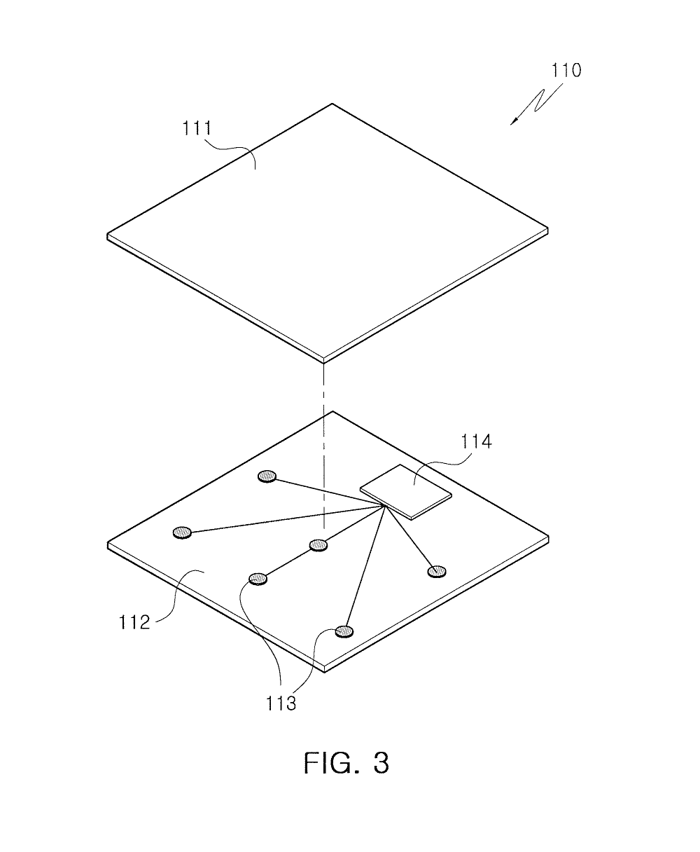

The weight sensor unit 110 is attached to the top portion of the bed, and transmits, in real-time, detected weight information to the controller 130 via wireless communication. As shown in FIG. 3, the weight sensor unit 110 includes a top plate 111 made of a soft material such as rubber, a bottom plate 112 made of a hard material, six pressure sensors 113 such as Force Sensing Resistors (FSR), and a sensor communication part 114, in which the pressure sensors 113 and the sensor communication part 114 are attached between the top and bottom plates 111 and 112. The sensor communication part 114 is connected to the pressure sensors 113 via communication lines, and serves to control the sensors and communicate therewith. The sensor communication part 114 receives pressure values such as detection information from the sensors 113, calculates an average value of the pressure values, and in real-time, transmits the average value to the controller 130. Here, the object of installing the pressure sensors 113 is to determine a presence and a movement of a subject rather than to precisely detect the weight thereof.

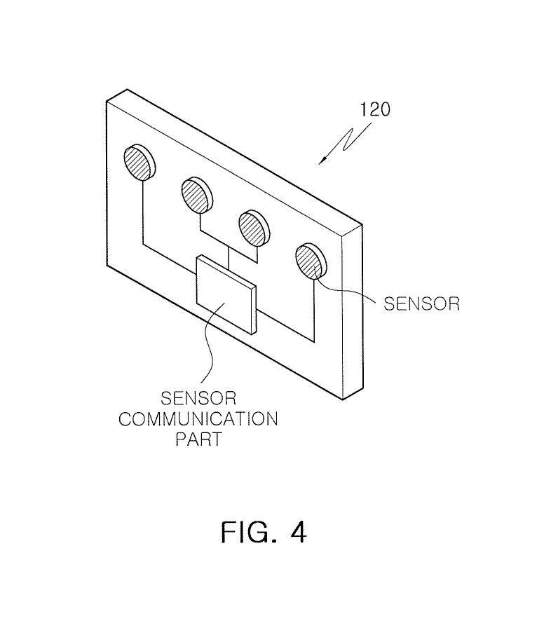

As shown in FIG. 4, the environment sensor units 120 attached to the bed include a plurality of sensors and a sensor communication part. The sensors include, for example, a temperature sensor, a moisture sensor, a luminance sensor, a noise sensor and a Piezoelectric InfraRed (PIR) sensor, and detect an environment surrounding the bed. The environment sensor units 120 transmit, in real-time, environment information from the sensors to the controller 120. Referring to FIG. 2, two environment sensor units 120 are attached to right and left portions a bed head, one unit to the right portion and the other unit to the left portion. The left environment sensor unit 120 includes PIR, luminance, temperature and moisture sensors, sequentially attached to the left bed head, and the right environment sensor unit 120 includes noise, temperature, luminance and PIR sensors, sequentially attached to the right bed head. Two or more of the environment sensors 120 can be attached to the bed in different sequences according to circumstances. Both the environment information transmitted from the environment sensor units 120 and the pressure values from the weight sensor unit 110 to the controller 130 may be referred to as “multiple sensor information.”

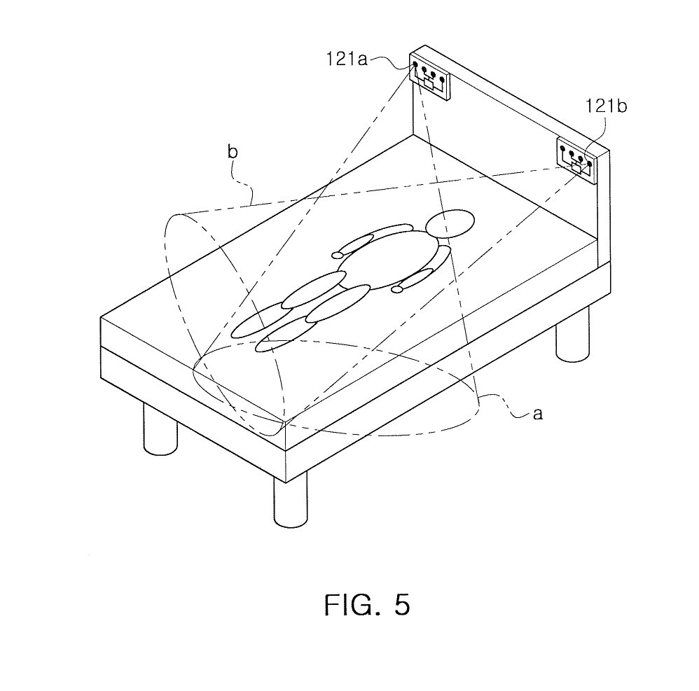

The PIR sensors of the sensor units 120 can detect movement in such a fashion as shown in FIG. 5. For example, the left PIR sensor 121a is located in the leftmost area of the left environment sensor unit 120, and the right PIR sensor 121b is located in the rightmost area of the right environment sensor unit 120, so that the left and right PIR sensors 121a and 121b detect the movement of the body generally in the angular range from 90 to 105 degrees. Accordingly, when the PIR sensors 121a and 121b are mounted, the sensing angles of the PIR sensors 121 are required to be oriented toward the inside of the bed rather than vertically downward of the bed. That is, the left PIR sensor 121a is oriented toward the right area of the bed (designated with “a”) and the right PIR sensor 121b is oriented toward the left area of the bed (designated with “b”), so that the system can detect a movement in only a predetermined area, which is detected by both the PIR sensors 121a and 121b.

The controller 130 communicates with the weight sensor unit 110 and the environment sensor units 120 via wireless communication such as Bluetooth, Zigbee or Ultra Wide Band (UWB), and collects and analyzes the multiple sensor information such as the pressure values and the environment information, transmitted through the wireless communication. The controller 130 is also connected to a wireless or wired internet, and transmits result information, acquired by the analysis of the multiple sensor information and the pressure values, to the wireless or wired internet.

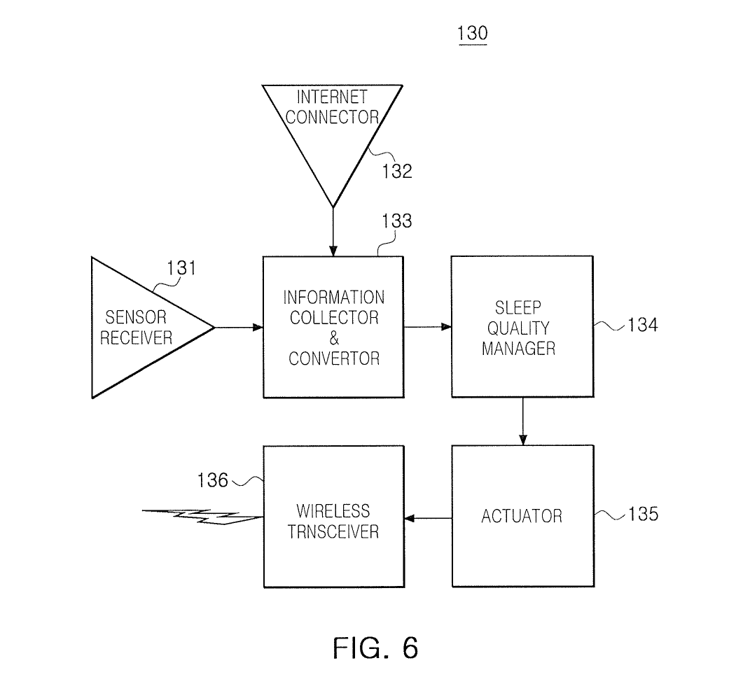

As shown in FIG. 6, the controller 130 includes a sensor information receiver 131, an internet connector 132, an information collector and converter 133, a sleep quality analyzer 134, an actuator 135 and a wireless transceiver 136. The controller 130 may also include a temporary information storage (not shown), which temporarily stores sleep-related information when it is collected.

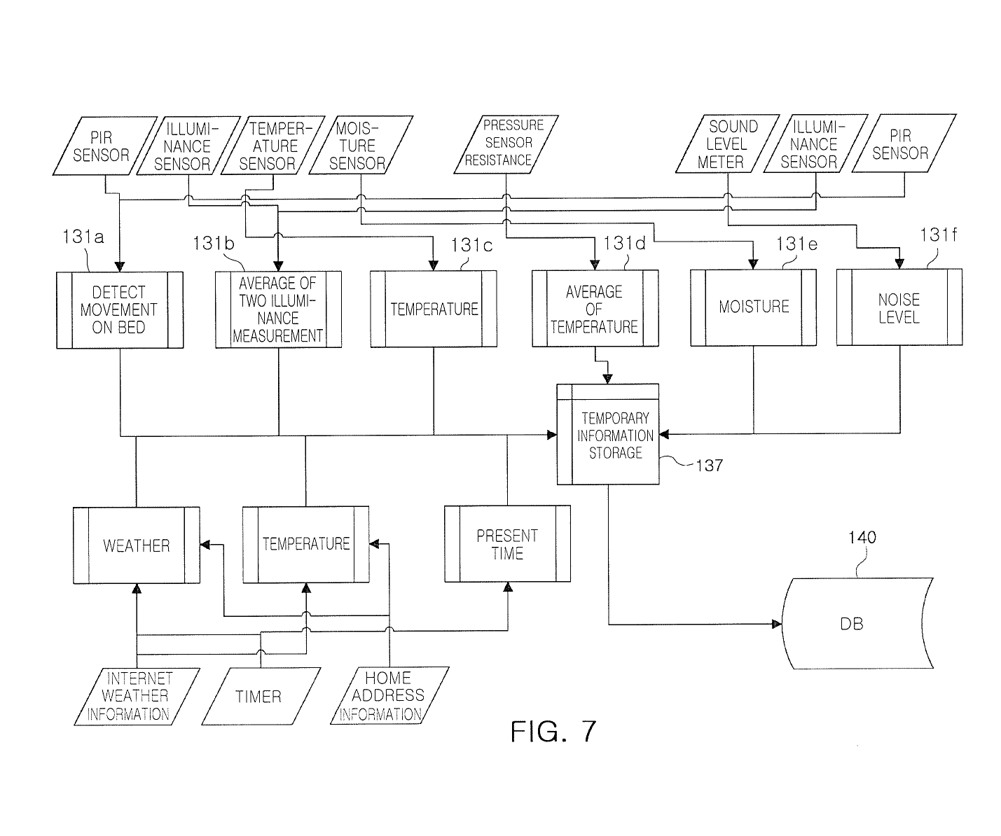

The controller 130 receives detection information from the sensors in the environment sensor units 120, which are located in the right and left parts of the bed. A data flow for the processing of the detection information will be described with reference to FIG. 7.

The sensor information receiver 131 of the controller 130 receives the multiple sensor information from the left and right environment sensor units 120. The multiple sensor information is related with movement detection, luminance, temperature, moisture and noise level. The sensor information receiver 131 also receives the pressure values from the weight sensor unit 110 through corresponding receiver modules 131a to 131f. The receiver modules 131b of the sensor information receiver 131 receive the luminance information from the left and right luminance sensors, and calculate the average of the received luminance information. Each of the receiver modules 131a to 131f of the sensor information receiver 131 stores the received or calculated information in a temporary information storage 137. The temporary information storage 137 may be included in the sensor information receiver 131 or the information collector and converter 133, or may be provided as a separate component between the sensor information receiver 131 and the information collector and converter 133.

The information collector and converter 133 receives weather information from the internet connector 132. Using the home address of the user, time and the received weather information, the information collector and converter 133 extracts weather, temperature and present time from corresponding modules. Additional information, including the extracted weather, the temperature and the present time, is temporarily stored in the temporary information storage 137.

The actuator 135 provides connection to electronic appliances that change temperature, moisture, luminance and the like, and the wireless transceiver 136 performs wireless communication with the electronic appliances.

The temporary information storage 137 stores, in a database 140, all sleep-related information (including the multiple sensor information and the additional information), which is temporarily stored in a predetermined time interval.

Now, with reference to the accompanying drawings, a detailed description will be made of a process of collecting sleep-related information and analyzing sleep states in order to manage the quality of sleep, which is carried out by the apparatus of managing the quality of sleep having the above-mentioned construction.

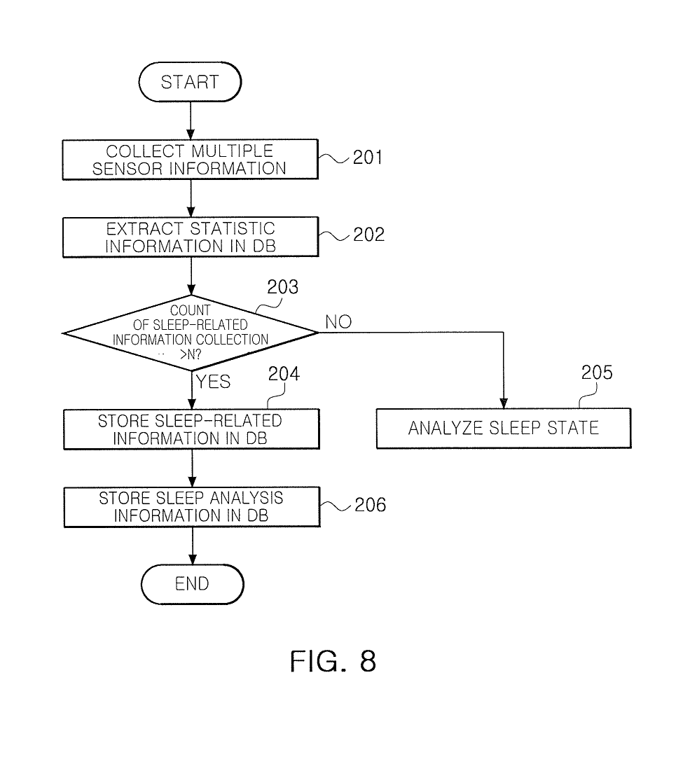

FIG. 8 is a flowchart illustrating a process of collecting sleep-related information and analyzing sleep states according to an embodiment of the invention.

Referring to FIG. 8, in step 201, the controller 130 collects multiple sensor information, transmitted from the sensor information receiver 131. In step 202, the controller 130 extracts statistics information of sleep-related information, which is previously stored in the database 140.

In step 203, the controller 130 analyzes the statistics information to check whether or not the count of collecting the sleep-related information of the user exceeds a threshold value N. If the count of collecting the sleep-related information of the user does not exceed a threshold value, the controller 130 proceeds to step 204. That is, the controller 130 stores, in the database 140, the multiple sensor information and other sleep-related information, collected and temporarily stored at present in the temporary information storage 137. Then, the controller 130 returns to step 201 to repeat collecting the multiple sensor information.

Conversely, if the count of collecting the sleep-related information of the user exceeds a threshold value, the controller 130 analyzes present sleep states by pattern comparison of the present collected multiple sensor information with the database 140 in step 205, and stores sleep analysis information, acquired as the result of the analysis, in the database 140 in step 206. Here, the pattern comparison indicates that previously-collected multiple sensor information, present in the database 140, is compared with presently-collected multiple sensor information, in which respective multiple sensor information is in the form of a vector in which values of respective sensors are designated with numbers or symbols. Various machine learning methods can be applied in order to assess sleep states based upon the information that is expressed as a vector. For example, K-nearest Neighbor learning can be applied. That is, K number of most similar data are found through vector comparison between previously-collected data, stored in the database 140, and presently-collected data. Of the K number of most similar data, a largest number of sleep states is discerned as sleep states for the present data. Alternatively, a Support Vector Machine (SVM) algorithm may be applied. That is, existing data patterns are learned beforehand to find internal parameters (e.g., support vectors), presently-collected sensor data are transmitted as input data to the SVM algorithm, and present sleep states are determined.

Below, a process of classifying the quality of sleep according to the result of the analysis of sleep states as mentioned above will be described in detail with reference to the accompanying drawings.

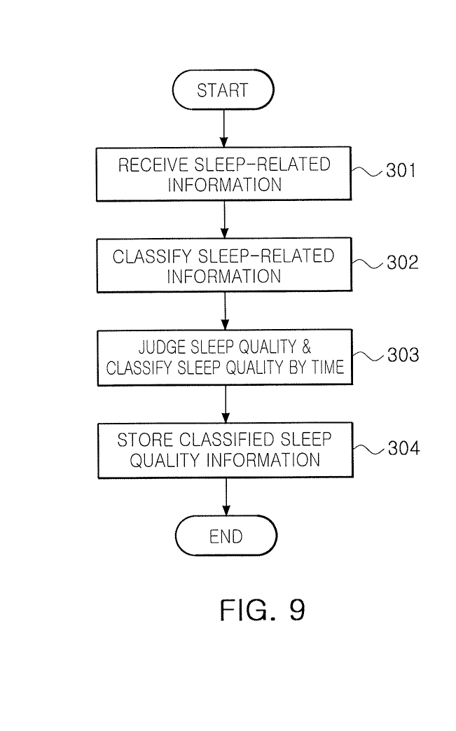

FIG. 9 is a flowchart illustrating a process of analyzing the quality of sleep in the apparatus of managing the quality of sleep according to an embodiment of the invention.

Referring to FIG. 9, the sleep quality analyzer 134 of the controller 130 receives the previously-stored sleep analysis information from the database 140 in step 301.

Then, in step 302, the sleep quality analyzer 134 of the controller 130 classifies the sleep analysis information by judging a number and a degree that the user turns over in a sleep, judging a number and a time that the user leaves the bed in a sleeping time, and measuring a high noise level time.

In step 303, the sleep quality analyzer 134 judges the quality of sleep based upon the result of classifying the sleep analysis information, and classifies the quality of sleep according to times. Then, in step 304, the sleep quality analyzer stores information of the quality of sleep, classified in step 303, in the database 140.

While the present invention has been described with reference to the particular illustrative embodiments and the accompanying drawings, it is not to be limited thereto but will be defined by the appended claims. It is to be appreciated that those skilled in the art can substitute, change or modify the embodiments in various forms without departing from the scope and spirit of the present invention.

What is claimed is:

1. An apparatus of managing quality of sleep, comprising:
a weight sensor unit including a plurality of pressure sensors, which detect pressures in response to a presence and a movement of a user;
an environment sensor unit including multiple sensors, which detect an environment surrounding the user in a sleep; and
a controller for collecting and analyzing information, detected by the weight sensor unit and the environment sensor unit, and classifying and managing the analyzed information according to quality of sleep.

2. The apparatus of claim 1, further comprising a database storing the information collected at the controller, and the information classified, at the controller, according to quality of sleep.

3. The apparatus of claim 1, wherein the multiple sensors include a motion sensor, an luminance sensor, a temperature sensor, a moisture sensor and a noise sensor.

4. The apparatus of claim 1, wherein the controller comprises:
a sensor information receiver for receiving, in real-time, pressure values detected from the weight sensor and multiple sensor information detected from the environment sensor unit;
an information collector and converter for collecting the pressure values and the multiple sensor information, and receiving additional information through connection to an internet; and
a sleep quality analyzer for analyzing the collected information, which includes the pressure values and the multiple sensor information, and classifying the collected information according to times based upon the collected information and the additional information.

5. The apparatus of claim 4, wherein the controller further includes a temporary information storage storing the collected information and the additional information.

6. The apparatus of claim 5, wherein the sleep quality analyzer receives a count of the collected information, collected from the temporary information storage, and statistics information of previously-stored sleep-related information, compares the received statistics information with a threshold value, and if the statistics value is larger than the threshold value, analyzes the collected information of the user.

7. The apparatus of claim 6, wherein the sleep quality analyzer classifies quality of sleep by judging a number and a degree that the user turns over in the sleep, judging a number and a time that the user leaves a bed in a sleeping time, and measuring a high noise level time.

8. The apparatus of claim 4, wherein the sensor information receiver calculates an average of the pressure values, and transmits the average to the information collector and converter.

9. The apparatus of claim 4, wherein the additional information includes internet weather information, present time and home address information.

10. A method of managing quality of sleep, comprising:
detecting, pressure of a presence and a movement of a user by a plurality of pressure sensors, and an environment surrounding a user in a sleep by multiple sensors;
collecting pressures, detected by the pressure sensors, and multiple sensor information, detected by the multiple sensors;
analyzing collected information, which includes the pressure values and the multiple sensor information; and
classifying the analyzed information according to quality of sleep to managing the classified information of quality of sleep.

11. The method of claim 10, wherein the analyzing of collected information comprises:
receiving statistics information of previously-collected sleep-related information;
analyzing the statistics information to acquire a count of collecting the sleep-related information, and comparing the count with a threshold value;
if the threshold value is larger than or the same as the count, analyzing sleep-related information collected at present; and
storing the analyzed sleep-related information.

12. The method of claim 11, wherein the analyzing of collected information comprises:
if the threshold value is smaller than the count, storing the collected information as it is.

13. The method of claim 11, wherein the classifying of the analyzed information according to quality of sleep comprises:
classifying quality of sleep according to time by judging a number and a degree that the user turns over in a sleep based upon a result of the analyzing of collected information;
classifying quality of sleep according to time by judging a number and a time that the user leaves a bed in a sleeping time based upon the result of the analyzing of collected information;
classifying quality of sleep according to time by measuring a high noise level time based upon the result of analyzing of collected information; and
storing information of classified quality of sleep.

14. The method of claim 11, further comprising:
receiving additional information through connection to an internet.

15. The method of claim 14, wherein the additional information includes internet weather information, present time and home address information.

16. The method of claim 10, wherein the multiple sensors include a motion sensor, an luminance sensor, a temperature sensor, a moisture sensor and a noise sensor.
